(19) United States
(12) Patent Application Publication
(10) Pub. No.: US 2005/0156566 A1
(43) Pub. Date: Jul. 21, 2005

(54) Battery charge control circuit for a battery pack consisting of rechargeable battery elements

(76) Inventors: Jan Thorsoe, Svenstrup (DK); Karl Oefele, Lenggries (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/511,328

(22) PCT Filed: Apr. 15, 2003
(86) PCT No.: PCT/EP03/03941

(30) Foreign Application Priority Data
Apr. 16, 2002 (DE) 102 16 831.8

(51) Int. Cl. H02J 7/00

(52) U.S. Cl. 320/116

(57) ABSTRACT

Disclosed is a battery control circuit for a battery pack consisting of rechargeable battery elements (9) which are arranged in respective parallel branches (3) battery voltage sources connected in parallel. State monitoring means are associated with each parallel branch (3) in order to monitor the state of the battery during a charging process of the battery pack and a respective switch (15), which can be controlled by the state monitoring means (11, 13, 17), is provided for the interruption or release of the charging current flow through the parallel branch (3) according to the state of the battery. The invention also relates to a discharge control circuit and a battery pack with an integrated battery charge control circuit/discharge control circuit.

The invention relates to a charge control circuit for a battery pack comprising rechargeable battery elements which are arranged in respective parallel branches of a parallel circuit of battery voltage sources.

Rechargeable battery elements may be combined in a known manner to form a rechargeable battery pack which can be used, for example, as a traction battery for operating devices, small vehicles, electric boats etc. In order to provide a sufficiently high battery capacity, it is possible to connect battery voltage sources having the same rated voltage in parallel, the sum of the individual capacities of the battery voltage sources in theory corresponding to the overall capacity of the battery pack. If the battery voltage sources provided in a parallel circuit with one another are intended to have a rated voltage which is above the rated voltage of the individual battery elements which are available or have been selected, it is possible to combine these individual battery elements in groups in series circuits, such that each group forms a parallel branch of the parallel circuit of battery voltage sources. The rated voltage of each group is given by the sum of the rated voltages of the series-connected individual batteries in the group.

Thus, for example, battery packs comprising nickel/cadmium battery elements (NiCd) or nickel/metal hydride battery elements (NiMH) may be designed such that they can replace conventional lead battery blocks in order to supply power to electrical loads having a comparatively high energy requirement.

It has been shown that such battery packs comprising NiCd elements or NiMH elements have significant advantages over the conventional lead battery blocks.

For example, NiCd and NiMH battery systems have a higher energy density than lead batteries given the same capacity and thus require correspondingly less space or installation area. The charging process takes considerably less time in the case of NiCd battery systems and in the case of NiMH battery systems than in the case of lead batteries having a corresponding capacity. A rechargeable battery pack comprising NiCd elements or comprising NiMH elements also has a considerably lower weight than a lead battery having the same capacity.

Battery packs comprising battery elements which can be treated initially on an individual basis can moreover be provided in a flexible manner for specific requirements as regards the rated voltage and also as regards the battery capacity.

If the battery pack is intended to have a rated voltage of, for example, 24 V, this can be realized by, for example, 20 NiCd individual batteries having a respective rated voltage of 1.2 V being connected in series. This then gives a battery block having a rated voltage of 24 V. In accordance with the battery capacity required, a corresponding number of such 24 V battery blocks can then be connected in parallel.

Trials using such battery packs comprising parallel-connected battery voltage sources which may for their part comprise a respective group of series-connected battery elements have shown, however, that in particular battery packs having a high capacity, i.e. battery packs having a large number of parallel-connected battery blocks, have a comparatively low battery life and, moreover, have impaired electrical properties. This could be attributed in particular to the fact that the parallel-connected battery blocks have had an undesired effect on one another owing to the different charge states. It was thus possible to detect, when discharging the battery pack via a load, considerable current flow between individual blocks which led to an unacceptably high level of heating of the battery pack which accelerates the ageing of the batteries.

This is a fundamental problem of such battery packs. The individual battery elements or battery cells have manufacturing tolerances, for example owing to production tolerances, and behave in a correspondingly different manner, in addition to which, the battery behavior depends to a considerable degree on the battery temperature. These undesired differences, which are not easy to prevent, between the battery cells are in the form of different electrical properties of the battery voltage blocks formed from them and coupled to one another in a parallel circuit. A particular problem are the differences with regard to charging behavior of the individual battery voltage blocks. For example, it may arise that individual blocks are charged beyond an optimum full charge state, in this case the electrical energy supplied to them being converted into heat to a significant extent, whilst other battery blocks of the battery pack have not yet reached their optimum full charge state. In the region of the overcharged battery blocks, in this case a considerable temperature increase results, which accelerates the ageing of the battery pack.

The present invention is based on the object of providing a charge control circuit and a discharge control circuit for a battery pack comprising rechargeable battery elements which are arranged in respective parallel branches of a parallel circuit of battery voltage sources and thus of making it possible to operate battery packs even having a relatively large capacity and having a large number of parallel-connected battery blocks in a reliable manner and such that they have a long life as electrical energy sources.

As regards the provision of a charge control circuit, it is proposed according to the invention to achieve this object for each parallel branch to have associated state monitoring means for monitoring the battery state of the parallel branch during a charging process of the battery pack, and for a respective switch, which can be controlled by the state monitoring means, to be provided in each parallel branch for the purpose of interrupting or releasing the current flow through the branch on the basis of the battery state.

The controllable switch, which is provided for the purpose of connecting or disconnecting a relevant parallel branch within the parallel circuit, may be controlled according to a predetermined charging program which is designed such that, during the entire charging process, no significant charge state differences between the individual parallel branches occur. One possibility is to disconnect the parallel branches which have reached a specific charge state until all of the parallel branches have reached this charge state, in order then to connect all of the parallel branches in the parallel circuit again in order to reach a next charge level, at which a corresponding comparison can then again be carried out by the parallel branches being disconnected corresponding to the sequence of this charge level being reached and when this charge level is reached, until all of the parallel branches have reached the same charge state.

In one preferred embodiment of the charge control circuit according to the invention, the state monitoring means of each parallel branch are set to detect the state “batteries in the parallel branch optimally charged” and, on detection of this state, to switch the controllable switch of this parallel branch to the interrupted state. “Interrupted state” means, for example, that a semiconductor switch is switched to the high-resistance state.

During a charging process, initially all of the parallel branches can thus be charged in parallel. Each individual parallel branch is monitored individually by its state monitoring means for when it reaches an optimum full charge state. Since each optimally charged parallel branch is disconnected by actuating the controllable switch and is thus isolated from the charging device connected to the parallel circuit, it is no longer possible for such parallel branches to be overcharged and thus heated beyond the permitted limit. The battery packs operated in this manner according to the invention have a comparatively long battery life.

The parallel branches are preferably formed from identical groups of series-connected battery elements which are connected in series with the respective controlled switch. The battery elements may be, for example, standard NiCd elements or standard NiMH elements. As has already been mentioned above, the rated voltage of the relevant parallel branch (battery voltage block) can be determined by the number of series-connected battery elements.

The charge state “parallel branch optimally charged” may be monitored in each case indirectly by measuring the temperature and/or by measuring the charge current.

According to one embodiment of the invention, the state monitoring means comprise temperature sensors for detecting the battery temperature, preferably for detecting an average battery temperature in the individual parallel branches.

This embodiment has a mode of operation in which the state monitoring means of a relevant parallel branch switch the controllable switch of the parallel branch to the interrupted state when the battery temperature in the parallel branch exceeds a predetermined temperature value, for example a temperature value in the range from 50° C. to 60° C. If this predetermined temperature value is exceeded, this is considered to be an indication that the parallel branch is now optimally fully charged.

The state monitoring means preferably comprise current measuring devices for detecting the current flowing through the individual parallel branches. In one mode of operation of the charge control circuit, the state monitoring means of a relevant parallel branch switch the controllable switch to the interrupted state when the charge current flowing through the parallel branch exceeds a predetermined current value for the duration of a predetermined time interval. This makes it possible to provide for the relevant parallel branch to be disconnected when its average charge current over the duration of two seconds exceeds a value of 10 amps. Such a high current flow over the predetermined time interval is taken as an indication that the state “parallel branch optimally charged” has been reached.

A further possibility of indirectly detecting the battery state “parallel branch optimally charged” is to monitor the temperature change in the relevant parallel branch per unit time. According to one development of the invention, it is thus provided for the state monitoring means of a relevant parallel branch to be set to switches the controllable switch of the parallel branch to the interrupted state when the change in battery temperature per unit time exceeds a comparison value depending on the respective charge current. In this sense, for example, a mode of operation of the charge control circuit can be provided in which the temperature is averaged over time intervals which depend on the respective charge current. If in this case two successive temperature average values make it possible to detect a respective temperature rise of, for example, in each case more than 1° Celsius, this may be taken as an indication that the battery charge state “parallel branch optimally charged” has been reached, with the result that the parallel branch is disconnected by activating the controllable switch and is thus isolated from the charging device. The averageing time interval for the temperature value averageing is dependent on the measured charge current through the relevant parallel branch. For example, the averageing time interval at a charge current of 5 amps may be, for example, 60 seconds, whereas it may be, for example, 240 seconds at a charge current of 1.25 amps.

According to one further embodiment of the charge control circuit according to the invention, the state monitoring means comprise a safety timer for each parallel branch, the state monitoring means being set so as to switch the controllable switch of the parallel branch to the interrupted state as soon as a charge time interval determined by the timer on the basis of the charge current flowing through the relevant parallel branch has expired. It is thus possible to provide, for example, for the charge time interval to expire after 1.2×60 minutes given an average charge current of 5 amps, whereas the charge time interval expires after only 1.2×240 minutes given an average charge current of 1.25 amps. The expiry that the charge time interval is taken to be an indication that the battery state “parallel branch optimally charged” has been reached.

According to one particularly preferred embodiment of the charge control circuit according to the invention, the state monitoring means are set to monitor the battery state “parallel branch optimally charged” based on a plurality of, in particular on all of the abovementioned criteria, namely on the criteria of exceeding the temperature value, exceeding a differential temperature value per unit time, exceeding a charge current value over a specific time interval and expiry of a charge time interval dependent on the charge current. As soon as the optimum full charge state has been detected based on one of these criteria and the controllable switch of the relevant parallel branch has subsequently been switched to the interrupted state, the parallel branch normally remains in the “disconnected state” until the battery is discharged, i.e. until it is used for supplying power to an electrical load.

The state monitoring means particularly preferably comprise a respective microprocessor per parallel branch for the purpose of controlling the controllable switch provided in the relevant parallel branch. The microprocessor may be in this case small, inexpensive microprocessors having a low power, since they do not need to meet particularly high requirements. Each of these microprocessors preferably serves the purpose of evaluating measured signals from one or more temperature sensors in the assigned parallel branch and is, moreover, an element of a measuring device for detecting the average charge current in the assigned parallel branch.

According to one embodiment of the invention, the microprocessors are connected to one another such that they can exchange data with one another.

According to one further embodiment of the invention, in addition to the microprocessors assigned to the individual parallel branch, a microprocessor with a greater power and thus being connected for data transfer is provided which has control functions in a charging process of the battery pack and which can be used to document specific events during a charging process or during a discharging process. In addition, such a main processor can be set in the context of the invention to indicate the respectively present capacity of the battery as required.

The invention also relates to a discharge control circuit for a battery pack comprising rechargeable battery elements which are arranged in respective parallel branches of a parallel circuit of battery voltage sources, each parallel branch, in series with the battery voltage source comprising one or more battery elements which is represented by it, having a respective controllable switch having an integrated diode, or one which is connected in parallel therewith which is conductive in the discharge current flow direction, the state monitoring means being provided and set so as to switch the controllable switch from a high-resistance state to a low-resistance state when a discharge current having a minimum current level flows through the diode.

The discharge control circuit according to the invention provides for the battery pack to be discharged in the manner which is yet to be explained below with reference to the figures, in such a way that more weakly charged parallel branches (battery blocks) are not charged in an uncontrolled manner by more heavily charged battery blocks.

The discharge control circuit is preferably combined with a charge control circuit according to the invention such that in each case one controllable switch in each parallel branch is associated with both the discharge control circuit and the charge control circuit. The same applies for further electronic elements, such as microprocessors.

A further subject of the invention is a battery pack having a battery control circuit which comprises a charge control circuit and a discharge control circuit, combined therewith, according to the invention.

The battery pack is thus a unit comprising rechargeable battery elements, electronic components of the battery control circuit and line connections, the rechargeable battery elements being arranged in respective parallel branches of a parallel circuit of battery voltage sources. Each battery voltage source is preferably in the form of a battery block which comprises two or more series-connected individual battery elements. The battery pack may have a support structure and/or a common housing for the battery blocks having associated electronic components of the battery control circuit. The battery blocks having relevant associated elements of the battery control circuit may be prepared as modules which can be introduced into the parallel circuit such that they can be replaced.

The number of battery blocks combined to form one battery pack is preferably variable such that, by adding battery blocks to the parallel circuit or, if necessary, by removing battery blocks from the parallel circuit, the battery capacity can be matched correspondingly to the respective use situation.

The invention will be explained in more detail below with reference to the figures.

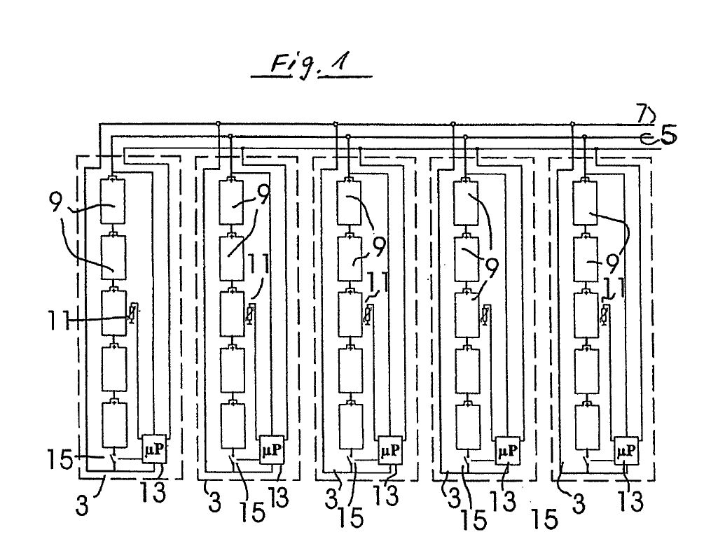

FIG. 1 shows a schematic, highly simplified illustration of a battery pack having an integrated charge control circuit and discharge control circuit according to the invention.

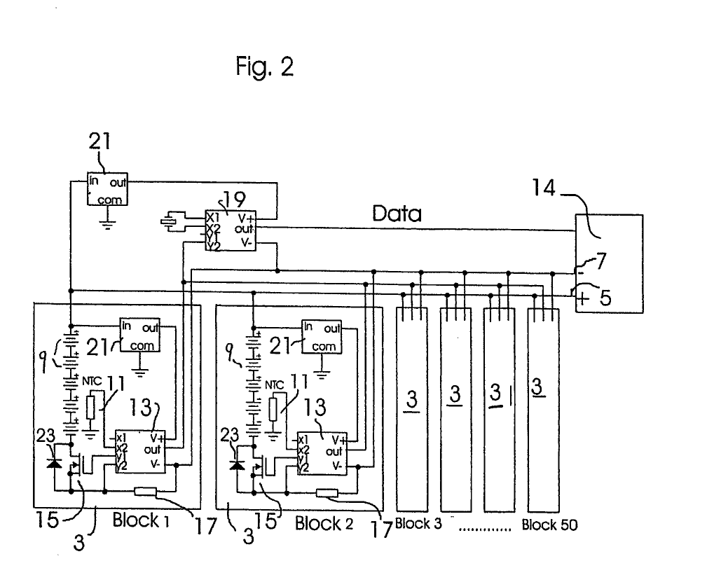

FIG. 2 shows a slightly more detailed, but still schematic illustration of the exemplary embodiment shown in FIG. 1.

The battery pack 1 comprises a large number of blocks 3, of which five are illustrated in FIG. 1 to be representative for a normally considerably larger number. The blocks 3 are represented by parallel branches of a parallel circuit which has electrical connections 5 and 7 for connecting them to a charging device or to an electrical load. Each block 3 (parallel branch) is formed from a number of series-connected individual battery elements 9 which may be, for example, NiCd or NiMH battery cells having a standard design. In the example shown in FIG. 1, five individual batteries are shown in each block 3. Depending on the required rated voltage of the blocks 3, however, more or fewer individual batteries may be provided per parallel branch.

In addition, each block 3 comprises a temperature sensor 11 which is arranged such that it can detect a temperature which is representative of the respective overall block 3. The temperature sensor is preferably a temperature measuring resistor, for example an NTC temperature measuring resistor, which is connected to a microprocessor 13, whose operation will be explained in more detail below with reference to FIG. 2. As can be seen in FIG. 1, in the exemplary embodiment of the invention considered here, there is provided for each battery block 3 a respective microprocessor 13 which controls a respective electronic switch 15. The switches 15 are in each case connected in series with the individual battery elements 9 of the associated block 3, with the result that they suppress the current flow through the block 3 (parallel branch) in the (high-resistance) interrupted state.

The exemplary embodiment shown in FIG. 1 is shown in slightly more detail in FIG. 2. As shown in FIG. 2, a charging device 14 is momentarily connected to the battery pack 1 in order to charge the battery pack 1.

The switches 15 are, in the exemplary embodiment, MOSFET transistors. Connected in series with the respective switch 15 is a current measuring resistor 17 in each parallel branch 3. The microprocessors 13 are capable of measuring the voltage drop across the current measuring resistors and of determining from this the charge current flowing through the relevant battery block 3.

19 in FIG. 2 indicates a separate microprocessor which is in connection for data transfer purposes with the individual microprocessors 13 of the battery blocks 3 and also with the charging device 14.

Voltage regulators 21 are provided for the purpose of providing regulated supply voltages for the microprocessors 13 and 19.

In one preferred charging mode of operation, the circuit arrangement shown in FIG. 2 operates as follows:

Once the battery pack 1 has been connected to the charging device 14, all of the microprocessors 13 are initialized so that they make available temperature measured values from the associated temperature sensors 11. If the temperature of one or more battery blocks 3 is outside of the temperature range of 0 to 40° C. during a charge starting phase, the main processor 19 emits a charge stop signal to the charging device 14 which then interrupts the charging process centrally. The interruption lasts until all of the battery blocks 3 have again assumed a temperature within the range of 0 to 40° C., preferably with a hysteresis of 5°, so that in the event that the temperature of a battery block 3 has risen to above 40° and this temperature rise has resulted in the charging process being interrupted, the charging process is only continued once the temperature of the battery blocks 3 has fallen to below 35° again.

As long as the temperatures of the battery blocks 3 remain within the safety temperature range of 0 to 40° during the starting phase, the charging process is continued.

The microprocessors 13 and the sensor elements connected thereto, namely the temperature sensors 11 and the current measuring resistors 17, are included in the state monitoring means which are individually associated with each individual battery block 3. During the charging process, the microprocessors 13 evaluate the signals of the sensor elements 11 and 17 in order to monitor the temperature of the individual battery blocks 3 and the respective charge current in the individual battery blocks 3.

If the measured temperature in a battery block 3 exceeds a value of 55° C. once the starting phase of the charging process has expired, this is a condition for disconnection of the relevant battery block 3, the microprocessor 13 associated with the battery block 3 switching the switch 15 to the interrupted state. As regards the disconnected battery block 3, it is a precondition that it has reached its optimum full charge state. There are also further criteria that indicate that the optimum full charge state has been reached by a relevant battery block 3. If in a battery block 3 the average charge current monitored by the associated microprocessor 13 exceeds a value of 2 C, for example 10 amps, over a duration of 2 seconds, the relevant microprocessor 13 switches the controllable switch 15 of the battery block 3 to the interrupted state. The battery block 3 is then considered to be optimally charged. (The charge current is often standardized to the unit C. If, for example, a battery having a capacity of 1 Ah is charged with 1 A charge current, this is referred to as charging with a charge current of 1 C.)

The microprocessors 13 also carry out an averageing of the measured temperature values over time intervals which depend on the measured charge current in the considered battery block 3. If the charge current is for example 1 C (i.e. in the example 5 amps), the average value of the temperature is calculated from measured values over a respective time interval of 60 seconds. If the measured charge current is only 0.25 C (1.25 amps), the average temperature is determined every 240 seconds. If the condition is fulfilled that two successive temperature average values make it possible to detect a temperature rise of in each case more than 1° C., the relevant microprocessor 13 switches the switch 15 controlled by it to the interrupted state. It is assumed that the battery block has then reached the optimally charged state. It should also be mentioned that the microprocessors 13 also take on timer functions, in particular the function of a safety timer which determines a charge time interval dependent on the measured charge current. If the average charge current is 1 C (in the example 5 amps), this time interval expires after 1.2×60 minutes. If the average charge current is 0.25 C (1.25 amps), the charge time interval expires after 1.2×240 minutes. In one particular embodiment of the invention, provision may be made for the microprocessors 13 to take account of changes in the average charge current in order to correspondingly match the charge time interval. Once the respective charge time interval has expired, the relevant microprocessor 13 switches the series switch 15 controlled by it to the interrupted state, and it is assumed that the relevant battery block has reached the optimally charged state.

Once a respective microprocessor 13 for the battery block 3 monitored by it has determined the fact that the optimally charged state has been reached, it transfers to low-power mode in which it has an extremely low power requirement and in which it remains until a discharging process of its battery block takes place. In the low-power mode, the microprocessors 13 carry out no temperature measurements or current measurements using the relevant sensors 11, 17. In one alternative embodiment of the invention, the low-power mode may also be characterized in that although the relevant microprocessor continues to detect the temperature measured values or current measured values, it does so with significantly reduced frequency.

The main processor 19 serves the purpose, inter alia, of in each case establishing how many battery blocks 3 are connected in each case to the charging device 14. The information on this is obtained from the individual microprocessors 13. In the example shown, the main microprocessor 19 controls the battery charging device 14 such that it limits the charge current to a respective maximum value depending on the number of battery blocks 3 connected to the charging device 14. If a microprocessor 13 thus informs the main processor 19 that the optimum full charge state of the relevant battery block 3 has been reached, the main microprocessor 19 drives the charging device 14 to reduce the charge current limit. In a corresponding manner, the charge current is limited further in a stepped fashion to smaller values when further battery blocks 3 have reached their optimum full charge state.

An optional feature is as follows: if the main processor 19 then establishes that only a specific minimum number of battery blocks 3, for example ten battery blocks 3, are still being charged, it causes the charging process for these remaining battery blocks 3 to be simultaneously interrupted, all of the switches 15 of these battery blocks 3 being transferred to the interrupted state.

This then brings about the situation in which the battery pack 1 is considered overall to be fully charged. Owing to the individual monitoring of the critical charge conditions of the individual battery blocks within the parallel circuit, namely the monitoring of the temperature behavior and the charge current, and owing to the individual disconnection of such battery blocks in which the optimum full charge state has been detected, the battery pack is overall charged in a safe and efficient manner, in which ageing-accelerating effects are suppressed.

According to one preferred embodiment of the invention, the battery blocks 3 representing the parallel branches are in the form of normally individually treated units which in each case contain their temperature measurement sensor 11, their switch 15, their current measuring resistor 17, their microprocessor 13 and, if necessary, further electronic elements such that they can be introduced into the parallel circuit such that they are electrically correctly connected essentially using a connection process, for example a plug-in process. Embodiments are conceivable in which the main processor 19 is omitted. If the intention is not to dispense with the functions of the main processor 19, these may then be taken on by one or more of the microprocessors 13.

On the other hand, embodiments are also conceivable in which each battery block does not have a dedicated microprocessor 13, but one or more central processors are provided which monitor the measured values from relevant temperature sensors 11 and current measuring devices 17 and control the switches 15.

The circuit arrangement shown in FIG. 2 permits not only a compensated battery charging process but also allows a safe discharging operation of the battery pack. For this purpose, an electrical load which can be provided with electrical power from the battery pack is connected to the outer connections 5 and 7 of the battery pack 1 in place of the charging device 14. The battery pack in this case manages with only two outer connections 5, 7 for the charging mode and the discharging mode. A discharge control circuit ensures that the battery blocks 3 are connected into the parallel circuit one after the other in sequence according to the level of their charge (voltage) for the purpose of contributing to the discharging process. In the case in which all of the battery blocks 3 should be charged to different levels, initially the most heavily charged battery block 3 is connected in order to supply power to the load. If this connected battery block 3, by being discharged, has then reached the charge state which the secondmost heavily charged battery block 3 has, the latter is connected in the parallel circuit for the purpose of contributing to the discharging process, such that now two battery blocks 3 are discharged via the connected load. A third or further battery block 3 etc. is then added, as soon as the battery blocks 3 which are already contributing to the discharging process have been discharged to such an extent that they have reached the charge state of this third or further battery block. This continues until all of the battery blocks 3 in the parallel circuit are connected and are supplying power to the electrical load. This discharging strategy prevents more heavily charged battery blocks 3 charging somewhat more weakly charged battery blocks 3 whilst an electrical load is being supplied with power, and, in the process, prevents undesirably high currents flowing which could lead to ageing-accelerating temperature increases in the battery pack.

In the exemplary embodiment shown in FIG. 2, the discharge control circuit comprises for each parallel branch, i.e. for each battery block 3, a diode 23 which is conductive in the discharge current flow direction. Such a diode may alternatively be realized by a diode path of the switch 15.

As regards the charge current in a charging process, the diodes 23 are reverse-biased. As regards the discharge current flow through the battery blocks 3 during discharging, the diodes 23 are forward-biased.

If now, starting from the state in which, following full charging of the battery pack, all of the switches (field-effect transistors) 15 are in their high-resistance interrupted state, an electrical load is connected to the connections 5 and 7 in place of the charging device 14, given different charge levels of the individual parallel branches, the most heavily charged battery block 3 will initially allow a discharge current to flow through its diode 23 and through the connected load. The associated microprocessor 13 registers the discharge current flow through the relevant diode 23 by it detecting a specific change in the voltage across the switch 15 (for example a voltage value of approximately 0.3 V being reached). The microprocessor 13 is programmed such that, when the onset of a discharge current having a minimum current level is detected in such a way, it switches the switch 15 of the relevant battery block 3 to the low-resistance state. This heavily charged battery block 3, which is the first one to be incorporated in the discharging process, cannot charge the remaining parallel-connected and initially more weakly charged battery blocks 3 in an undesirable manner, since the switches 15 of these remaining battery blocks 3 have been switched still from the previous charging process to be highly resistive and block the diodes 23, which are connected in parallel with the switches 15, in the charge current flow direction. Only when the battery block 3, which was initially the most heavily charged and was incorporated first in the discharging process, has been discharged to such an extent that its charge state essentially corresponds to that of a further battery block 3 in the parallel circuit, such that this further battery block 3 can also allow a discharge current to flow through its diode 23 and through the connected load, does the associated microprocessor 13 switch the relevant switch 15 to the low-resistance state when the discharge current flow is detected, such that now this further battery block, too, is incorporated in the supply of power to the load. This continues until finally all of the battery blocks 3 of the battery pack have been connected in so as to supply power to the connected load.

Depending on the charge state of the battery blocks 3 after a charging process, two or more battery blocks 3 may also be incorporated at the same time in the discharging process as long as they have essentially the same charge states.

Provision may be made for the microprocessors 13 to be switched from their low-power mode, in which they were monitoring the voltage across the switch 15, to the normal operating mode when the onset of the discharge current through the respective diode 23 is detected as described above, in order to monitor the battery state of the relevant battery block 3 and, if necessary, to communicate with the main processor 19 (if provided). In particular, the circuit shown in FIG. 2 may be designed to monitor whether a discharge current flows in one or more battery blocks 3 in an undesirable manner, whilst a charge current 3 flows in other battery blocks. If this state is detected, the circuit then ensures that the switch 15 is immediately switched back to the high-resistance interrupted state in the battery blocks 3 in which the charge current flow was detected. Only when the charge state balance of the relevant battery blocks 3 has been again compensated to such an extent that in each case a discharge current flows in the case of the load connected, is the respective battery block 3 connected for the purpose of contributing to the discharging process.

1. (canceled)

2. The charge control circuit as claimed in claim 16 characterized in that the state monitoring means (11, 13, 17) of a parallel branch (3) are set to switch the controllable switch (15) to the interrupted state when it detects a battery state “parallel branch fully charged”.

3. The charge control circuit as claimed in claim 16, characterized in that the parallel branch (3) are formed from identical groups of series-connected battery elements (9) which are connected in series with the respective controlled switch (15).

4. The charge control circuit as claimed in claim 16,
characterized in that the state monitoring means (11, 13, 17) comprise temperature sensors (11) for detecting the battery temperature in the individual parallel branches (3).

5. The charge control circuit as claimed in claim 4,
characterized in that the state monitoring means (11, 13, 17) of a relevant parallel branch (3) are set to switch the controllable switch (15) of the parallel branch (3) to the interrupted state when the battery temperature detected by the temperature sensor (11) in the parallel branch (3) exceeds a predetermined temperature value.

6. The charge control circuit as claimed in claim 16,
characterized in that the state monitoring means (11, 13, 17) comprise current measuring devices (13, 17) for detecting the current flowing through the individual parallel branch (3).

7. The charge control circuit as claimed in claim 6,
characterized in that the state monitoring means (11, 13, 17) are set to switch the controllable switch (15) of the relevant parallel branch to the interrupted state when the charge current flowing through the parallel branch (3) exceeds a predetermined current value for the duration of a predetermined time interval.

8. The charge control circuit as claimed in claim 16,
characterized in that the state monitoring means (11, 13, 17) are set to switch the controllable switch (15) of the respective parallel branch (3) to the interrupted state when the change in the battery temperature per unit time exceeds a comparison value depending on the respective charge current through the parallel branch (3).

9. The charge control circuit as claimed in claim 16,
characterized in that the state monitoring means (11, 13, 17) comprise a safety timer (13), and in that the state monitoring means (11, 13, 17) switch the controllable switch of the respective parallel branch to the interrupted state when a charge time interval, which is determined by the timer (13) on the basis of the charge current flowing through the relevant parallel branch (3), has expired.

10. The charge control circuit as claimed in claim 16,
characterized
in that the state monitoring means (11, 13, 17) comprise a respective microprocessor (13) per parallel branch (3) for the purpose of controlling the respective switch (15).

11. (canceled)

12. The discharge control circuit as claimed in claim 17
characterized in that the controllable switches (15) are transistors, in particular field-effect transistors.

13. The discharge control circuit as claimed in claim 17,
characterized in that the state monitoring means comprise at least one microprocessor (13, 19), preferably at least in each case one microprocessor (13) for each parallel branch (3).

14. A battery control circuit, comprising the charge control circuit as claimed in claim 16 and a discharge control circuit combined therewith, wherein the discharge control circuit comprising state monitoring means (11, 13, 17) and switches (15), which can be controlled by the state monitoring means, for interrupting the current flow or releasing the current flow, each parallel branch having, in series with the battery voltage source (3) comprising one or more battery elements (9) represented by it a respective controllable switch (15) having an integrated diode (23), or one which is connected in parallel therewith, which is conductive in the discharge current flow direction,
characterized in that the state monitoring means (13) are set so as to switch the respective controllable switch (15) from a high-resistance state to a low-resistance state when a discharge current having a minimum current level flows through the diode (23).

15. A battery pack having the charge control circuit as claimed in claim 16 integrated therein.

16. A charge control circuit for a battery pack comprising rechargeable battery elements (9) which are arranged in respective parallel branches (3) of a parallel circuit of battery voltage sources, the charge control circuit comprising state monitoring means (11, 13, 17) for monitoring the battery state of battery elements (9), and the charge control circuit comprising switches (15), which can be controlled by the state monitoring means, for interrupting the current flow or releasing the current flow,
characterized in that each parallel branch (3) has associated state monitoring means (11, 13, 17), and in that a respective switch (15) is provided in each parallel branch (3), it being possible for said respective switch (15) to be controlled on the basis of the battery state, which is monitored by the state monitoring means (11, 13, 17), of the relevant parallel branch (3), in order to selectively block or release only this relevant parallel branch (3) for the current flow.

17. A discharge control circuit for a battery pack comprising rechargeable battery elements (9), which are arranged in respective parallel branches of a parallel circuit of battery voltage sources (3), the discharge control circuit comprising state monitoring means (11, 13, 17) and switches (15), which can be controlled by the state monitoring means, for interrupting the current flow or releasing the current flow, each parallel branch having, in series with the battery voltage source (3) comprising one or more battery elements (9) represented by it, a respective controllable switch (15) having an integrated diode (23), or one which is connected in parallel therewith, which is conductive in the discharge current flow direction,
characterized in that the state monitoring means (13) are set so as to switch the respective controllable switch (15) from a high-resistance state to a low-resistance state when a discharge current having a minimum current level flows through the diode (23).

18. A battery pack having the discharge control circuit as claimed in claim 17 integrated therein.

19. A battery pack having the charge control circuit as claimed in claim 16, integrated therein and also having integrated therein a discharge control circuit which comprises state monitoring means (11, 13, 17) and switches (15), which can be controlled by the state monitoring means, for interrupting the current flow or releasing the current flow, each parallel branch having, in series with the battery voltage source (3) comprising one or more battery elements (9) represented by it, a respective controllable switch (15) having an integrated diode (23), or one which is connected in parallel therewith, which is conductive in the discharge current flow direction,
characterized in that the state monitoring means (13) are set so as to switch the respective controllable switch (15) from a high-resistance state to a low-resistance state when a discharge current having a minimum current level flows through the diode (23).
